(19) United States
(12) Patent Application Publication
(10) Pub. No.: US 2007/0246116 A1
(43) Pub. Date: Oct. 25, 2007

(54) Drainage pipe slope measuring device

(76) Inventors: B. David Peak, Auburn, AL (US); David Branscomb, Auburn, AL (US); Ken Hopkins, Emporia, KS (US); Wes Bowden, Emporia, KS (US)

Correspondence Address: LITMAN LAW OFFICES, LTD., P.O. BOX 15035, CRYSTAL CITY STATION, ARLINGTON, VA, 22215, US

(21) Appl. No.: 11/706,313

(22) Filed: Feb. 15, 2007

Related U.S. Application Data
(60) Provisional application No. 60/793,632, filed on Apr. 21, 2006.

(51) Int. Cl. F16L 55/00

(52) U.S. Cl. 138/104

(57) ABSTRACT

The drainage pipe slope measuring device includes a housing having an upper surface and a lower surface. The upper surface has an opening formed therethrough, the lower surface preferably having a substantially concave or arcuate cross-sectional contour adapted for flush mounting against the drainage pipe. A spirit level vial is mounted within the housing and is positioned adjacent the opening. The vial is preferably formed from at least partially transparent or translucent material and is adapted for containing a liquid and a gas bubble. Indicia is formed on the container and is visible through the opening so that, when the housing is mounted on the drainage pipe, a position of the gas bubble with respect to the indicia provides the user with a visual indication of the slope of the drainage pipe. The vial is preferably divided into separately colored regions to provide the user with further visual contrast.

### CROSS-REFERENCE TO RELATED APPLICATION

This application claims the benefit of U.S. Provisional Patent Application Ser. No. 60/793,632, filed Apr. 21, 2006.

### BACKGROUND OF THE INVENTION

1. Field of the Invention

The present invention relates to level indicator devices for use by plumbers, carpenters and electricians, and particularly to a drainage pipe slope measuring device for ensuring that drainage pipes meet the minimum slope required by building codes.

2. Description of the Related Art

Drain-waste pipes form an important part of any plumbing installation. Local ordinances and building codes generally require that drain pipes be installed with a slight pitch or downward slope leading away from the plumbing installation to help prevent waste and drain water from backing up into the house or building plumbing system. The angle of declination may vary according to the diameter of the drain pipe. A common requirement is that a drain or sewer line three inches or less in diameter must slope vertically downward one-quarter inch per foot of travel, while drain pipes greater than three inches in diameter must slope vertically downward one-eighth of an inch downward for each foot of travel.

Drain pipes may be made from various types of materials, such as copper, galvanized metal, and plastic, including polyvinyl chloride and polybutylene. Further, drain pipes may be installed in locations that may be difficult to reach, such as in ditches, under crawl spaces, etc. Even when drain pipes are located in accessible locations, the pipes may have only a short length of uniform diameter, being interrupted by expansion or compression fittings to join lengths of pipe. Contractors, building code inspectors, plumbers, and privately engaged home inspectors all have a need to check the grade of drainage pipes, both in new plumbing installations, as well as ensuring continued compliance with building codes in existing plumbing installations.

The traditional carpenter's bubble level is not well adapted for determining the compliance of drainage pipe installations with the mandated slope. The carpenter's bubble level typically has a pair of flat parallel flanges joined by a web perpendicular to the flanges. The bubble level vial(s) are mounted in the web. The flat flanges are difficult to maintain against the body of the drain pipe, which is usually cylindrical. When looking down into a drain pipe installed in a ditch, or looking at a drain pipe installed in a crawl space from the side, it can be difficult to see the level's vial. Horizontal and vertical level vials are not adapted to measure a downward slope, so that one end of the carpenter's level must be held in the air so that the bubble is level while the gap between the bottom flange and the pipe is measured or estimated. Even when the carpenter's level has a third vial that is angularly adjustable, the angle must be estimated and the meniscus is relatively short, leading to inaccurate measurements. Finally, the carpenter's level is not fixed to the pipe, so that each person making measurements must provide his own level, which varies in precision according to the machining of the contact surfaces, the mounts for the bubble levels, and the skill of the person using the level.

Typical carpenter's levels are permanent devices; i.e., they are not meant for disposable usage. The carpenter's level must be mounted on the surface, then removed once the slope of the surface has been measured. For surfaces that must be inspected by multiple people, or multiple times, such as drainage pipes, it may be desirable to have a level that may be fixed to the surface and left there. Such a level would preferably be formed from disposable materials to minimize the cost of materials that will, eventually, be covered by earth or construction materials.

While various devices have been proposed to remedy at least some of these problems, none have been found entirely satisfactory, and none is in common use. As a result, quite often instruments are not used to measure the slope of drainage pipes. Contractors, plumbers, and even code inspectors quite often resort to an eyeball estimate instead.

Thus, a drainage pipe slope measuring device solving the aforementioned problems is desired.

### SUMMARY OF THE INVENTION

The drainage pipe slope measuring device includes a housing having an upper surface and a lower surface, and a front and rear portion. The housing is preferably contoured to resemble an arrow, with the head of the arrow being formed on the front portion of the housing. When positioned on a drainage pipe, the arrow head preferably points in the direction of declination of the drainage pipe.

The upper surface has an opening formed therethrough, and the lower surface preferably has a concave or substantially arcuate or semicylindrical cross-sectional contour adapted for flush mounting against the drainage pipe. An adhesive layer may be formed on the lower surface for attaching the housing to the drainage pipe and, prior to application, the adhesive layer may be covered by a releasable backing strip. Alternatively a band, cable, tie, or like fastener may be used to fasten the device to the pipe.

An elongate spirit level vial is mounted within the housing and is positioned adjacent the opening. The vial is preferably formed from at least partially transparent or translucent material and is adapted for containing a viscous liquid and a gas bubble. Indicia is formed on the container, or on a separate window mounted within the opening, and is visible through the opening so that when the housing is mounted on the drainage pipe, a position of the gas bubble with respect to the indicia provides the user with a visual indication of the angular position of the drainage pipe with respect to the horizontal.

Further, the opening is defined by first and second longitudinally opposed side edges, and the at least partially transparent or translucent material forming the vial has first and second colors associated therewith. A first region of the vial extending between the first side edge and the indicia is colored with the first color, and a second region of the vial extending between the indicia and the second side edge is colored with the second color, thus providing further visual contrast to the user.

These and other features of the present invention will become readily apparent upon further review of the following specification and drawings.

### BRIEF DESCRIPTION OF THE DRAWINGS

FIG. 1 is an environmental, perspective view of a drainage pipe slope measuring device according to the present invention.

FIG. 2 is a top view of the drainage pipe slope measuring device according to the present invention.

FIG. 3 is an exploded end view of the drainage pipe slope measuring device according to the present invention.

FIG. 4 is a top, perspective view of an alternative embodiment of the drainage pipe slope measuring device according to the present invention.

FIG. 5 is a bottom, perspective view of the drainage pipe slope measuring device of FIG. 4.

Similar reference characters denote corresponding features consistently throughout the attached drawings.

### DETAILED DESCRIPTION OF THE PREFERRED EMBODIMENTS

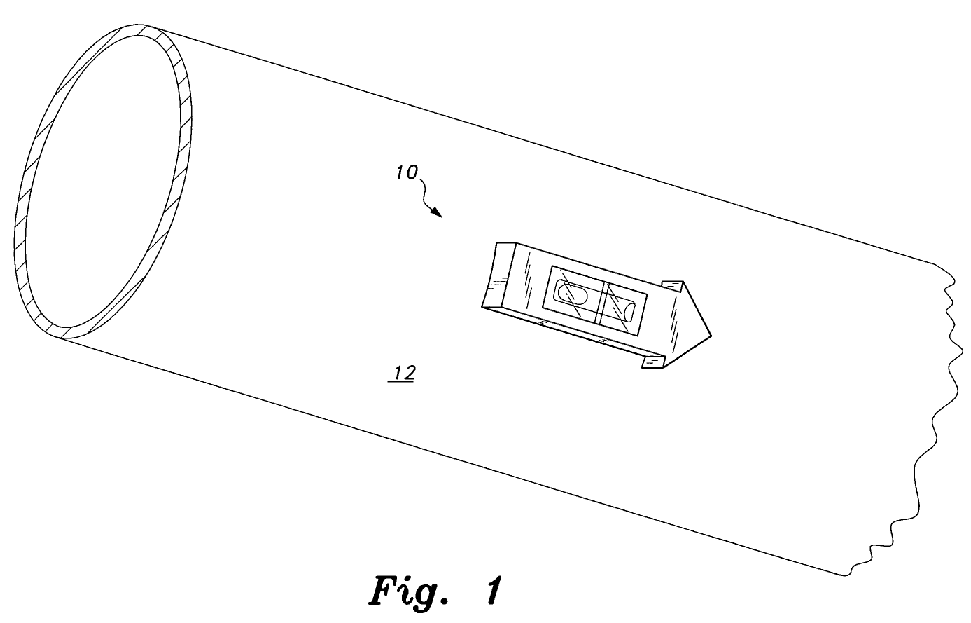

The present invention, a first embodiment of which is illustrated in FIGS. 1-3, is directed to a drainage pipe slope measuring device, designated generally as 10 in the drawings. Drainage pipes, such as drainage pipe 12, shown in FIG. 1, are typically required by building codes and regulations to have a particular angular declination with respect to the horizontal. For example, a drainage pipe may be required under residential or commercial building codes to have a declining slope of one-quarter to one-eighth of an inch fall (in the vertical direction) per one foot of drainage piping. The particular angular positioning is required to allow the waste water and material flowing through pipe 12 to efficiently move through the pipe under the force of gravity.

The drainage pipe slope measuring device 10 may be mounted to the exterior of a drainage pipe, such as pipe 12, to provide the user with a visual indication of whether the slope of the pipe 12 satisfies the particular codes and regulations regarding the angle of declination of drainage pipes. It should be understood that device 10 may further be applied to any suitable article, particularly articles having an arcuate contour, so that the user may determine if the article is positioned at a desired angle.

Device 10 includes a housing 20, which is preferably formed from a rugged and lightweight material, such as rigid plastic or vinyl. Housing 20 may be adapted for disposable usage of device 10, or may be designed for permanent or reusable applications. In the preferred embodiment, housing 20 is formed from a disposable material, such as a plastic material, allowing the device 10 to be permanently fixed to pipe 12. Pipe 12 will be covered with earth or other construction materials, and it is desirable to minimize the cost associated with the loss of device 10, which is permanently fixed to the pipe 12.

As shown in the drawings, in the preferred embodiment, housing 20 has a cross-sectional contour, when viewed from above or below, in the shape of an arrow. The front portion 16 of housing 20 forms the arrowhead, and the rear portion 18 forms the arrow's tail. As shown in FIG. 1, the housing 20 is preferably positioned on pipe 12 so that the arrow head points in the direction of declination, providing the user with a clear visual indication of the direction of declination. It should be understood that housing 20, however, may have any shape or contour, and indicia forming an arrow for orientation of the device on the pipe may be imprinted, embossed, or otherwise formed on the housing 20. In the preferred embodiment, housing 20 is between about one and 1½ inches in length, between about one-half of an inch to one inch in width, and between about one-eighth of an inch to three-quarters of an inch in height, although it should be understood that housing 20 may have any dimensions.

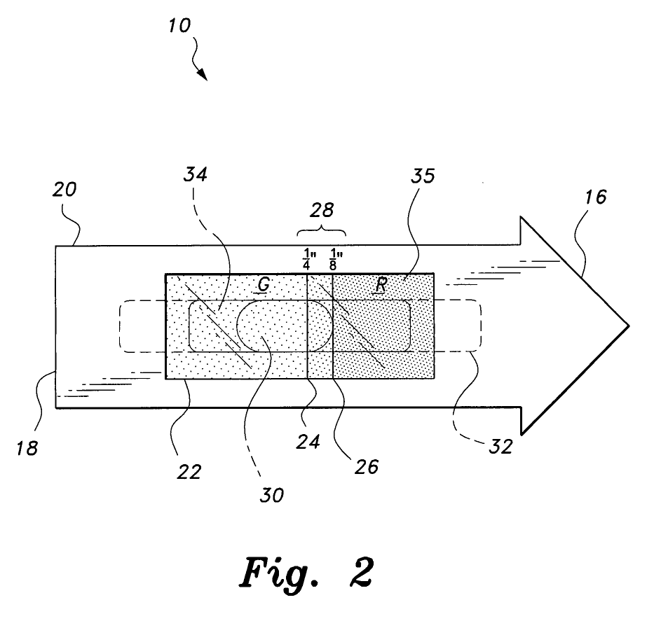

As best shown in FIG. 2, the upper surface of housing 20 has an opening 22 formed therethrough. Opening 22 is shown as having a substantially rectangular contour. However, it should be understood that opening 22 may have any dimension or configuration. A sealed spirit level vial 32 is mounted within housing 20 and is positioned adjacent opening 22 so that sealed vial 32 is visible through opening 22. The sealed vial 32 is formed from an at least partially transparent material, such as glass or clear plastic, and contains a liquid 34 and a gas bubble, which may be an air bubble 30.

Gas bubble 30 has a density less than that of liquid 34, so that gas bubble 30 will always rise, in the vertical direction, to achieve a position above that of liquid 34. Thus, when housing 20 is inclined or declined, the gas bubble will move in a longitudinal direction along the length of vial 32. The user may observe the position of gas bubble 30 through opening 22, thus providing the user with a visual indication of the angular position of housing 20 and the surface, such as pipe 12, to which housing 20 is mounted.

Indicia 28 may be imprinted, or otherwise formed, on the upper surface of housing 20. In FIG. 2, indicia 28 include an indication of one-quarter of an inch and one-eighth of an inch fall with respect to one foot of drainage pipe, as described above. However, it should be understood that indicia 28 may include any desired indication of angular position. Further, calibrated marker lines 24, 26 are provided to further visually indicate the position of gas bubble 30 with respect to vial 32 and housing 20. Marker lines 24, 26 may be in alignment with indicia 28, as shown. Marker lines 24 may be etched, imprinted or otherwise formed on a translucent window 35, which is mounted within opening 22, or may, alternatively, be formed directly onto the outer surface of vial 32.

When housing 20 is mounted on drainage pipe 12 (as shown in FIG. 1), the slope of drainage pipe 12 may be visually determined by the position of gas bubble 30 with relation to indicia 28 and marker lines 24, 26. In addition, further visual contrast may be provided by dividing window 35 (or the outer surface of vial 32) into two separately colored regions. In FIG. 2, the region between the left edge of window 35 and the “⅛” marker line 26 is preferably colored green (denoted by G in the Figure). The region between the “⅛” marker line 26 and the right edge of window 35 is preferably colored red (denoted by R in the Figure). Thus, in addition to observing the position of the bubble 30 with respect to marker lines 24, 26 and indicia 28, the user may observe whether the bubble 30 is in region G or region R.

In the preferred embodiment, when the housing 20 is either positioned horizontally or is inclined, gas bubble 30 extends into the red region R. Thus, the user may quickly determine, through visual inspection alone, that the drainage pipe 12 is not sufficiently angled.

It should be understood that green and red are exemplary colors and that any desired colors or texture may be utilized. Further, it should be understood that the positioning of gas bubble 30 with respect to the separately colored regions, the marker lines and the indicia, may indicate any desired angular positioning, dependent upon the particular application of the user.

The marker lines 24 and 26 are calibrated so that the degree of declination is indicated by the right edge of bubble 30. When the right edge of bubble 30 is tangent to line 24, the declination of pipe 12 is ¼ inch per one foot. When the right edge of bubble 30 is tangent to line 26, the declination of pipe 12 is ⅛ inch per one foot.

It should be understood that the “¼″” and “⅛″” indicia 24, 26 are for exemplary purposes only and the measurement of inclination, and visual representation of the inclination, is dependent upon the particular code of the locality. The green region G, for example, may extend from the left edge of window 35 to the “¼″” mark, if so desired, and, further, “¼″” and “⅛″” may be replaced by any other desired measurement. In the preferred embodiment, illustrated in FIG. 2, if any portion of bubble 30 extends into red zone R (i.e., beyond the ⅛″ marking 26), the angle of declination of pipe 12 violates the code. In this preferred embodiment, the zones G and R, and the indicia 24, 26, are calibrated so that bubble 30 extends into the red zone R by approximately ⅛ of an inch when device 10 is positioned on a horizontal surface (i.e., a pipe with zero angle of declination).

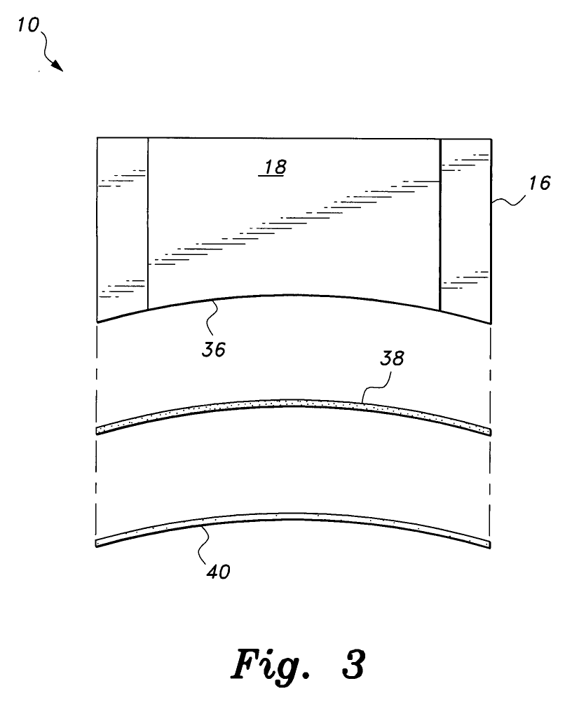

As best shown in FIG. 3, the lower surface 36 preferably has an arcuate or semicylindrical cross-sectional contour, being concave to allow the housing 20 to be stably mounted on a drainage pipe having a substantially cylindrical contour. An adhesive layer 38 may be applied to lower surface 36, allowing the housing 20 to be secured to the exterior surface of drainage pipe 12. It should be understood that housing 20 may be secured to pipe 12 through usage of any suitable fixture, such as a rubber band, for example. Prior to application, adhesive layer is, preferably, covered with a releasable backing cover strip 40, which may be removed to expose adhesive layer 38.

It will be understood that housing 20 may be formed as a unitary body, comprised entirely of a rigid material, or the upper portion of housing 20 may be formed of rigid material and the lower portion of housing 20 may be formed of a resilient material, such as natural or synthetic rubber, so that the lower surface 36 may expand or compress in order to conform to the radius of curvature of the pipe 12 in order to accommodate pipes of different, diameter, in particular, pipes having a diameter greater than three inches and pipes having a diameter of less than three inches.

Further, multiple devices 10 may be provided and sold in a kit, for application to multiple drainage pipes, either in a single location or multiple locations. Such kits could be provided to plumbers, building inspectors, builders, contractors, project managers and the like.

It will also be obvious to those skilled in the art that instead of having a dual calibration for both ¼ inch and ⅛ inch, the device 10 may be provided calibrated for only a single angle of declination. In this case, instead of the indicator and calibration disclosed above, the device may be provided with spaced apart marker lines so that the pipe 12 has the required slope when the bubble 30 is centered between the spaced apart marker lines. Calibration may be provided by mounting the vial 32 within the housing 20 at the required slope, or by forming the arcuate lower portion with a graded or tapered thickness from end-to-end corresponding to the required slope, so that lower surface 36 slopes downward at the required angle of declination.

The provision of adhesive layer 38 permits device 10 to be attached to pipe 12, thereby freeing the plumber's hands to adjust the pipe 12 to the required angle of declination. The device 10 may be removed and disposed of after use, or the device may be left attached to the pipe 12 so that both the plumber, contractor or other installer and the code inspector can check the slope of the device using the same measurement tool. Thereafter, the device 10 may be removed and disposed of, or may be left in place to ensure continued compliance with code requirements, should reinspection or repair be required.

As described above, any suitable fastener may be utilized to attach device 10 to pipe 12. For permanent usage, a releasable fastener, such as a rubber band, for example, would be preferable. Preferably, at least one pair of hooks or other suitable engaging members would be formed on housing 20, for engaging the rubber bands or other fixtures. The rubber bands would wrap around both housing 20 and the outer surface of pipe 12 to releasably secure the housing 20 thereto.

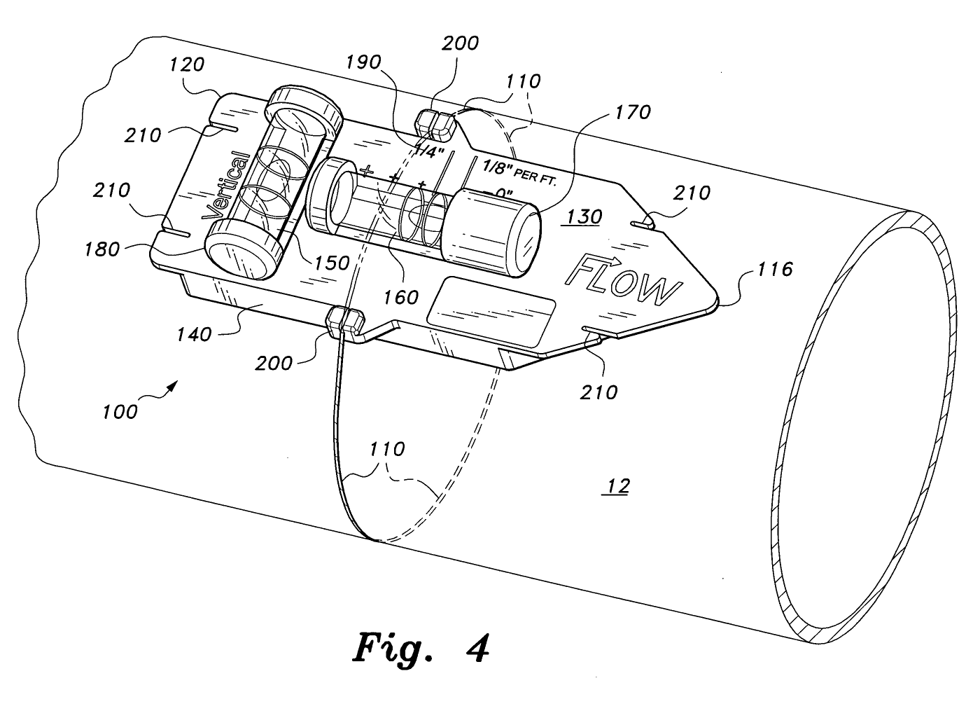

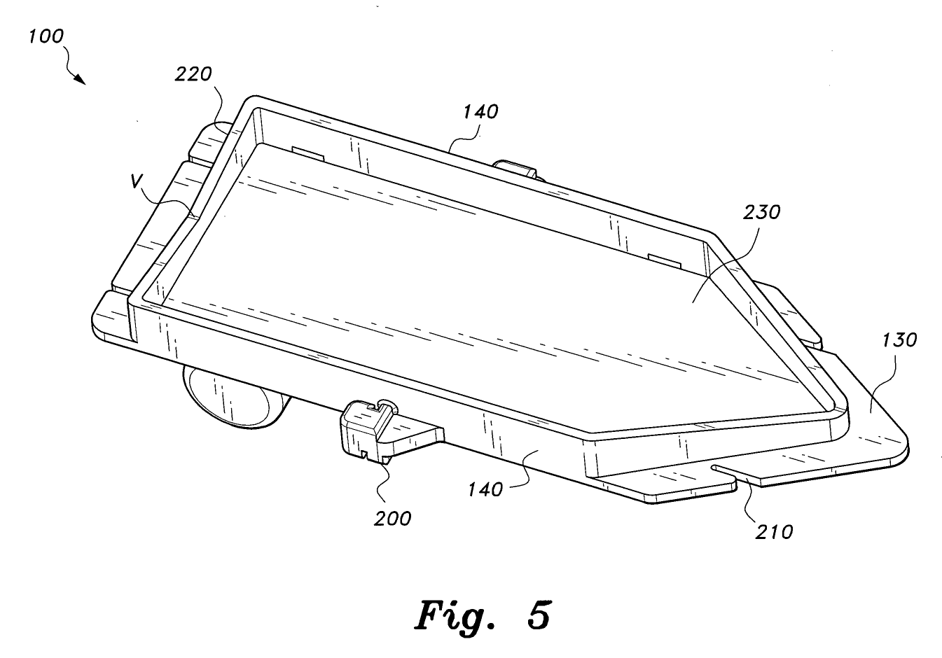

In the alternative embodiment illustrated in FIG. 4, the drainage pipe slope measuring device 100 includes a housing 120 having an upper portion and a lower portion. The upper portion includes a plate or other support structure, and defines an upper surface 130. The lower portion includes at least one wall mounted to the upper plate, and projecting downwardly therefrom. In the preferred embodiment, the lower portion includes at least a pair of side walls 140 and a rear wall 220, as best shown in FIG. 5. Device 100 is constructed from materials similar to those described above with respect to device 10 of FIGS. 1-3.

First and second mounts 170, 180 are formed on upper surface 130 for retaining first and second spirit level vials 150, 160. Each vial 150, 160 is similar in construction to vial 32 of the embodiment of FIGS. 1-3. However, as shown, first and second vials 150, 160 are positioned substantially orthogonal with respect to one another, allowing the user to measure angle or slope along two orthogonal axes simultaneously. The usage of a second vial may be particularly useful in measuring alternative configurations of pipe, such as in plumbing associated with toilets, which include pipes mounted at approximately 90° to the pipes illustrated in FIG. 1.

The front portion of upper surface 130 is preferably formed into an arrowhead shape (similar to front portion 16 of device 10), and indicia 190 may be formed on upper surface 130, similar to measurement indicia 28 of device 10. It should be understood that indicia 190 may be any suitable indicia, including measurement related figures or the like, and may further be selected from a variety of differing styles, fonts and languages.

Rather than being adhesively secured to pipe 12, device 10 is either permanently or releasably affixed to pipe 12 by a band or cord 110. As shown in FIG. 4, a pair of slotted retainers 200 are formed on laterally opposed edges of upper surface 130 for receiving and retaining a portion of band 110 so that band 110 may be tied or otherwise secured about pipe 12 to secure the device 100 thereto. It should be understood that any suitable band 110 may be used. Such bands may include, but are not limited to, wires, string, elastic cord, rubber bands, cable ties and the like.

In addition, a plurality of slots 210 are formed in longitudinally opposed edges of the upper surface 130, allowing the band 110 to be wound about device 100, and releasably secured thereto when not in use. It should be understood that, though shown as being releasably attached to the device 100, the band 110 may alternatively be permanently affixed to the device 100. Further, a variety of bands 110, each having a different length or circumference may be provided, allowing the user to select a particular line band 110 to fit a particular pipe. Further, an adhesive, such as that described above with regard to FIGS. 1-3, may alternatively or additionally be utilized.

FIG. 5 illustrates the bottom side of device 100. As shown, lower walls 140 and rear wall 220 are mounted to, and project downwardly from, upper surface 130. As shown, rear wall 220 preferably has a substantially V-shaped contour with a central vertex V, allowing the device 100 to be mated to pipes of varying sizes. A cavity 230 is defined by the lower walls 140, rear wall 220 and upper surface 130 for receiving a protruding portion of the pipe's surface. It should be understood that the rear wall 220 may have any desired contour.

It should be understood that any suitable spirit level devices may be used in the above embodiments. Any suitable materials may utilized in the construction of the vials, any desired indicia or other markings may be formed on the surfaces of the vials, and any desired fluid may be utilized to form the indicating bubbles within the vials. In a preferred embodiment, a liquid forming a reflective-type bubble is utilized. Such bubbles are well-known, and one is described in U.S. Pat. No. 6,681,494, which is hereby incorporated by reference in its entirety.

It is to be understood that the present invention is not limited to the embodiments described above, but encompasses any and all embodiments within the scope of the following claims.

I claim:

1. A drainage pipe slope measuring device, comprising:
a housing having an upper surface and a lower surface, the upper surface having an opening formed therethrough, the lower surface having a substantially arcuate cross-sectional contour adapted for mounting on a drainage pipe;
an elongated spirit level vial mounted within the housing, the vial being positioned adjacent the opening in order to be visible therethrough, the vial containing a liquid and a gas indicator bubble;
indicia formed on the vial in a first color and a second color, the indicia being calibrated to indicate downward slope of the drainage pipe, the vial 11 being formed of translucent material having a first region of the vial extending from one end of the vial to the indicia formed of the first color, and a second region of the vial extending between the opposite end of the vial to the indicia formed of the second color, the first and second colors providing visual contrast to the user.

2. The drainage pipe slope measuring device according to claim 1, further comprising means for securing the housing to the drainage pipe.

3. The drainage pipe slope measuring device as recited in claim 2, wherein said means for securing the housing to the drainage pipe comprises an adhesive layer formed on the lower surface of said housing.

4. The drainage pipe slope measuring device as recited in claim 2, wherein said means for securing the housing to the drainage pipe comprises an elongated flexible fastener removably attached to the housing, the fastener being adapted for extension around both the housing and the drainage pipe to secure the housing to the drainage pipe.

5. The drainage pipe slope measuring device as recited in claim 1, wherein said housing is substantially arrow-shaped.

6. A drainage pipe slope measuring device, comprising:
a housing having an upper surface and a lower surface, the upper surface having an opening formed therethrough, the lower surface having a substantially arcuate cross-sectional contour adapted for mounting on a drainage pipe;
an elongated spirit level vial mounted within the housing and being positioned adjacent the opening in order to be visible therethrough, the vial containing a liquid and a gas indicator bubble;
an elongate translucent window mounted within the opening; and
indicia formed on the transparent window in a first color and a second color, the indicia being calibrated to indicate downward slope of the drainage pipe, the window having a first region extending from one end of the window to the indicia formed of the first color, and a second region of the window extending between the opposite end of the window to the indicia formed of the second color, the first and second colors providing visual contrast to the user.

7. The drainage pipe slope measuring device as recited in claim 6, further comprising means for securing the housing to the drainage pipe.

8. The drainage pipe slope measuring device as recited in claim 7, wherein said means for securing the housing to the drainage pipe comprises an adhesive layer formed on the lower surface of said housing.

9. The drainage pipe slope measuring device as recited in claim 7, wherein said means for securing the housing to the drainage pipe comprises an elongated flexible fastener removably attached to the housing, the fastener being adapted for extension around both the housing and the drainage pipe to secure the housing to the drainage pipe.

10. The drainage pipe slope measuring device as recited in claim 6, wherein said housing is arrow-shaped.

11. A drainage pipe slope measuring device, comprising:
a housing having an upper portion and a lower portion, the upper portion forming a support plate having an upper surface and a lower surface, the lower portion including a pair of sidewalls extending from the lower surface of the support plate and projecting downwardly therefrom, the lower portion being adapted for releasable mounting on a drainage pipe;
first and second spirit level vials mounted on the upper surface of the upper portion of the housing, the first and second spirit level vials each defining a central axis, the central axis of the first spirit level vial being orthogonal to the central axis of the second spirit level vial, each of the spirit level vials containing a liquid and a gas indicator bubble;
indicia means cooperating with the bubble for indicating slope of the drainage pipe; and
means for releasably securing said housing to the drainage pipe.

12. The drainage pipe slope measuring device as recited in claim 11, wherein said means for releasably securing said housing to the drainage pipe comprises an elongated flexible fastener removably attached to the housing, the fastener being adapted for extension around both the housing and the drainage pipe to secure the housing to the drainage pipe.

13. The drainage pipe slope measuring device as recited in claim 12, further comprising at least one retaining member mounted to the upper portion of said housing for releasably retaining the flexible fastener.

14. The drainage pipe slope measuring device as recited in claim 13, wherein a plurality of slots are formed in the upper portion of said housing, said flexible fastener being wound about said housing and releasably received within the plurality of slots for storage and transport.

15. The drainage pipe slope measuring device according to claim 11, wherein said means for releasably securing said housing to the drainage pipe comprises a layer of adhesive disposed on the lower portion of said housing.

16. The drainage pipe slope measuring device as recited in claim 11, wherein the lower portion of said housing further comprises a rear wall, the rear wall and pair of side walls defining a chamber for releasably engaging an upper surface of the drainage pipe.

17. The drainage pipe slope measuring device as recited in claim 16, wherein the rear wall has a substantially V-shaped contour.

18. The drainage pipe slope measuring device as recited in claim 11, wherein the upper portion of said housing is arrow-shaped.

19. The drainage pipe slope measuring device as recited in claim 11, wherein said indicia means comprises indicia formed on said first and second spirit level vials, the indicia being calibrated to indicate slope of the drainage pipe.

20. The drainage pipe slope measuring device as recited in claim 11, wherein said indicia is formed in a first color and a second color, each said spirit level vial being formed of translucent material having a first region of the respective spirit level vial extending from one end of the spirit level vial to the indicia formed of the first color, and a second region of the respective spirit level vial extending between the opposite end of the spirit level vial to the indicia formed of the second color, the first and second colors providing visual contrast to the user.
